(19) United States
(12) Patent Application Publication
(10) Pub. No.: US 2008/0137226 A1
(43) Pub. Date: Jun. 12, 2008

(54) Method and apparatus for testing servo data on a disk medium in a disk drive

(75) Inventors: Katsuki Ueda, Ome-shi (JP); Masahide Yatsu, Akishima-shi (JP); Hideo Sado, Ome-shi (JP); Toshitaka Matsunaga, Ome-shi (JP); Shoji Nakajima, Kodaira-shi (JP); Seiji Mizukoshi, Nishitama-gun (JP); Shinichirou Kouhara, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/979,596

(22) Filed: Nov. 6, 2007

(30) Foreign Application Priority Data
Dec. 7, 2006 (JP) 2006-330946

(51) Int. Cl. G11B 5/596; G11B 20/00; G11B 20/10

(52) U.S. Cl. 360/77.06; 369/47.53

(57) ABSTRACT

According to one embodiment, in a disk drive having the function of performing a self-servo writing, the CPU is configured to calculate correction values for only those of servo tracks which have been designated and to store the correction values in servo sectors, when a process of calculating STW-RRO correcting values during a self-run test.

### CROSS-REFERENCE TO RELATED APPLICATIONS

This application is based upon and claims the benefit of priority from Japanese Patent Application No. 2006-330946, filed Dec. 7, 2006, the entire contents of which are incorporated herein by reference.

### BACKGROUND

1. Field

One embodiment of the present invention relates to a hard disk drive. More particularly, the invention relates to an improvement to a method of calculating a RRO correction value for use in servo control.

2. Description of the Related Art

In most disk drives, a representative example of which is a hard disk drive, the positioning of the heads is controlled in accordance with the serve data (servo pattern) that is recorded on disk media, i.e., data-recording media. That is, the heads are moved to target positions (i.e., target tracks) on the disk media, in accordance with the servo data the heads have read. Each head writes or reads data at the target position on a disk medium.

The servo data is recorded on the disk medium in the servo-writing Block included in the manufacture of the disk drive. Recently, a method of writing servo data has been proposed, which can write the servo data at high efficiency. In this method, the servo data is recorded on the disk medium in the form of a spiral servo pattern or a multi-spiral servo pattern, which is used as base pattern. By using the basic pattern, the servo data, i.e., a concentric servo pattern, is written to the disk medium. (See, for example, U.S. Pat. No. 5,668,679 and U.S. Pat. No. 6,965,486B1.)

The concentric servo pattern is composed of a plurality of servo sectors that are arranged on one track at regular intervals in the circumferential direction of the disk medium. The concentric servo pattern means many servo tracks composed of these servo sectors. In each servo sector there is recorded servo data that contains address codes of the track and sector and a servo-burst pattern.

In the servo writing Block, servo data is written as a distorted concentric track, not on an ideal concentric track, due to the wobbling of the disk medium that is rotating, also known as disk run-out or repeatable run-out (RRO). This distortion of the track is called servo-track write RRO (STW-RRO). If the servo data recorded in such a distorted servo track is used, a large error may occur in positioning the head at the target track during the reading/writing of data, or the data tracks in which the user data is recorded may be arranged at an uneven pitch.

To prevent such a head-positioning error or such an uneven data-track pitch, the servo system of the disk drive (more precisely, the main controller of the disk drive, i.e., the CPU) performs a correction process using an STW-RRO correction value for suppressing STW-RRO, whenever the head position is controlled by using the servo data reproduced from the disk medium. (Hereinafter, the STW-RRO correction value will be referred to as correction value.) As a result, the head can trace a data track that is almost as concentric as desired, whereby the user data is read or written with high precision.

In the manufacture of a disk drive, a so-called self-run test is performed after the servo data has been written to each disk medium. This test includes a servo-data test. In the servo-data test, the head-positioning control is performed after the disk media, each having servo data recorded on it in the servo-writing Block, have been incorporated into the disk drive to be shipped as a product.

A method of acquiring a correction value has been proposed for use in the above-mentioned self-run test. This method is to obtain a correction value through repeated calculations. (See, for example, U.S. Pat. No. 6,061,220 and U.S. Pat. No. 6,529,362.) In this method, the read head included in each head reads servo data from each servo sector on one disk medium, and a calculation is repeated, thereby providing a correction value that can suppress STW-RRO to make the head trace a data track very similar to an ideal concentric track.

Thus, a correction value for suppressing the STW-RRO is calculated in the self-run test. The correction value thus calculated may be recorded in, for example, a servo sector provided on the disk medium. Then, STW-RRO can be compensated for, during the head-positioning control.

However, a long time is required to calculate a correction value in the self-run test, because each disk medium has many tracks. The time required is long, particularly for any medium of high-recording density, which has a great number of tracks. The process of calculating the correction value will be one factor that prolongs the manufacture of the disk drive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a servo-track writer according to an embodiment of this invention;

FIG. 2 is a diagram explaining the servo data recorded on a disk medium in the embodiment;

FIG. 3 is a diagram illustrating the configuration of a servo sector according to the embodiment;

FIG. 4 is a block diagram showing the major components of a disk drive according to the embodiment;

FIG. 5 is a diagram illustrating an example of a servo pattern according to the embodiment;

FIGS. 6A and 6B are diagrams explaining the seek speed and acceleration performed in the self-servo writing Block according to the embodiment;

FIG. 7 is a diagram showing a magnified drawing of a multi-spiral servo pattern according to the embodiment;

FIG. 8 is a diagram illustrating the configuration of a spiral servo pattern according to the embodiment;

FIG. 9 is a pattern diagram explaining the correlation and decorrelation induced by the distortion of the servo tracks in the embodiment; and

FIG. 10 is a flowchart explaining the sequence of calculating a correction value in the embodiment.

### DETAILED DESCRIPTION

Various embodiments according to the invention will be described hereinafter with reference to the accompanying drawings. In general, according to one embodiment of the invention, there is provided a disk drive that includes a calculating unit which uses the servo data read the head has read from the disk medium, thereby calculating correction values that suppress changes synchronous with the rotation of the disk medium during the positioning control of the head, and a calculation control unit which controls the calculating unit, and causes the calculating unit to calculate a correction value for one of the servo tracks which has been designated, and stores the correction values, thus calculated, into a storage unit.

(Servo Writing Process)

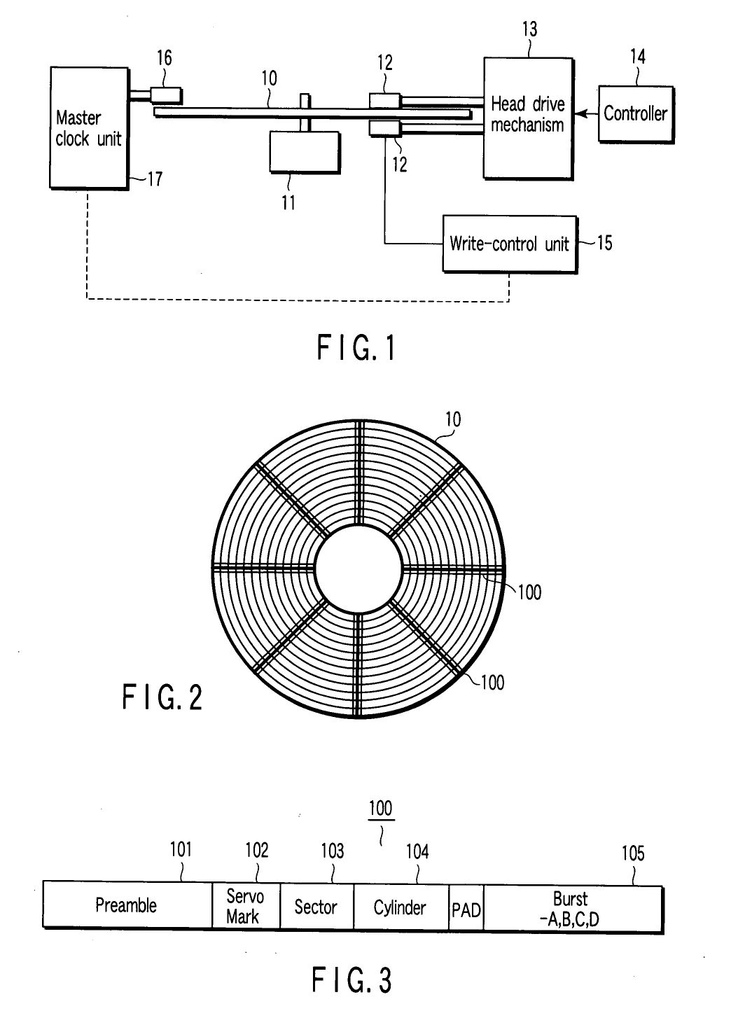

According to an embodiment, FIGS. 1 to 5 explain the servo writing process of writing servo data to a disk medium 10 during the manufacture of a disk drive according to the embodiment. FIG. 1 is a block diagram showing the major components of the servo-track writer (STW) used in the servo writing process.

As in most cases, the servo-track writer is installed in a clean room. It writes servo data to the disk medium 10 with no data thus far recorded on it. The servo-track writer has a spindle motor 11, a servo head 12, a head drive mechanism 13, a controller 14, a write-control unit 15, a clock head 16, and a master lock unit 17. The servo head 12 is provided to write servo patterns.

The controller 14 controls the head drive mechanism 13, which moves the servo head 12 to a designated position over the disk medium 10 rotated by the spindle motor 11. The write-control unit 15 supplies servo data to the servo head 12. In accordance with the servo data the servo head 12 writes a servo pattern at a designated position on the disk medium 10.

In the embodiment, the servo-track writer writes a spiral servo pattern 50 on the disk medium 10, as shown in FIG. 5. The spiral servo pattern is used as base pattern. In practice, the base pattern is a multi-spiral servo pattern, which is recorded on the disk medium 10 and which consists of a plurality of spiral servo patterns.

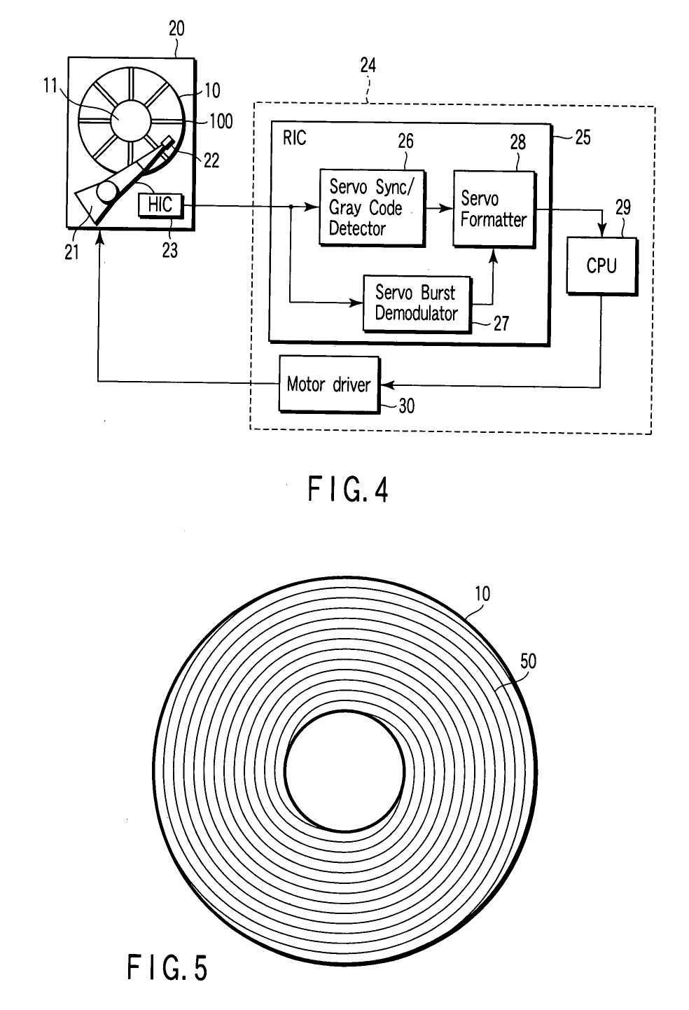

Further, as shown in FIG. 2, concentric servo patterns are written on the disk medium 10 by the self-servo writing method. In the self-servo writing method, the disk medium 10, on which the base pattern has been written by the servo-track writer, is incorporated in a disk drive 20 as can be understood from FIG. 4. The disk drive 20 to be shipped as a product writes concentric servo patterns on the basis of the base pattern recorded on the disk medium 10.

As shown in FIG. 2, the concentric servo patterns are composed of servo sectors 100, which constitute servo tracks. In other words, each servo track is composed of a plurality of servo sectors 100 (eight servo sectors, here) that are arranged at regular intervals in the circumferential direction. As shown in FIG. 3, each servo sector 100 includes a preamble 101, a servo mark 102, a sector address 103, a cylinder (track) address 104, and servo-burst patterns (A to D) 105. The servo sector 100 also includes a postamble (PAD).

As shown in FIG. 4, the disk drive 20 has a head 22 (comprising a read head and a write head), an actuator (head-moving mechanism) 21, a head amplifier 23, and a circuit board 24. The actuator 21 holds the head 22 (i.e., read head and write head). The circuit board 24 holds a read/write channel 25, a microprocessor (CPU) 29, and a motor diver 30. The read/write channel 25 includes servo-system circuits 26 to 28.

The read/write channel 25 is a signal-processing circuit that processes read/write signals for reading and writing servo data and user data. The servo-system circuits are a detector 26, a demodulator 27, and a servo formatter 28. The detector 26 detects sector addresses 103 and cylinder addresses 104. The demodulator 27 demodulates servo-burst patterns 105. The motor driver 30 drives the voice coil motors provided in the spindle motor 11 and actuator 21, under the control of the CPU 29.

The CPU 29 is the main controller of the disk drive 20. It performs a calculation process to calculate a correction value (STW-RRO correction value) that suppresses the STW-RRO change during the self-servo writing process and the self-run test according to the present embodiment.

(Process of Calculating the Correction Value)

In the present embodiment, the CPU 29 calculates a correction value (i.e., STW-RRO correction value) for each sector during the self-run test performed after the self-servo writing process. The correction value thus calculated is stored in the designated area of the servo sector. The process of calculating this correction value will be explained below.

In the self-run test, the head-positioning control is carried out with respect to the disk medium 10 on which servo data has been written in the self-servo writing process. A servo testing process is thereby performed to measure the head-positioning precision.

In the self-servo writing process, the CPU 29 first causes the head 22 to trace the spiral servo pattern, i.e., base pattern 50, recorded on the disk medium 10, as described above. The CPU 29 then causes the head 22 to write concentric servo patterns (servo sectors 100 forming servo tracks) on the disk medium 10, as shown in FIGS. 2 and 3. The concentric servo patterns thus written are used when the disk drive 20 is shipped as a product.

(STW-RRO)

The base pattern 50 recorded on the disk medium 10 is one spiral servo pattern. As FIG. 5 shows, it has a specific length and is a multi-spiral pattern that consists of about 200 to 300 spiral servo patterns.

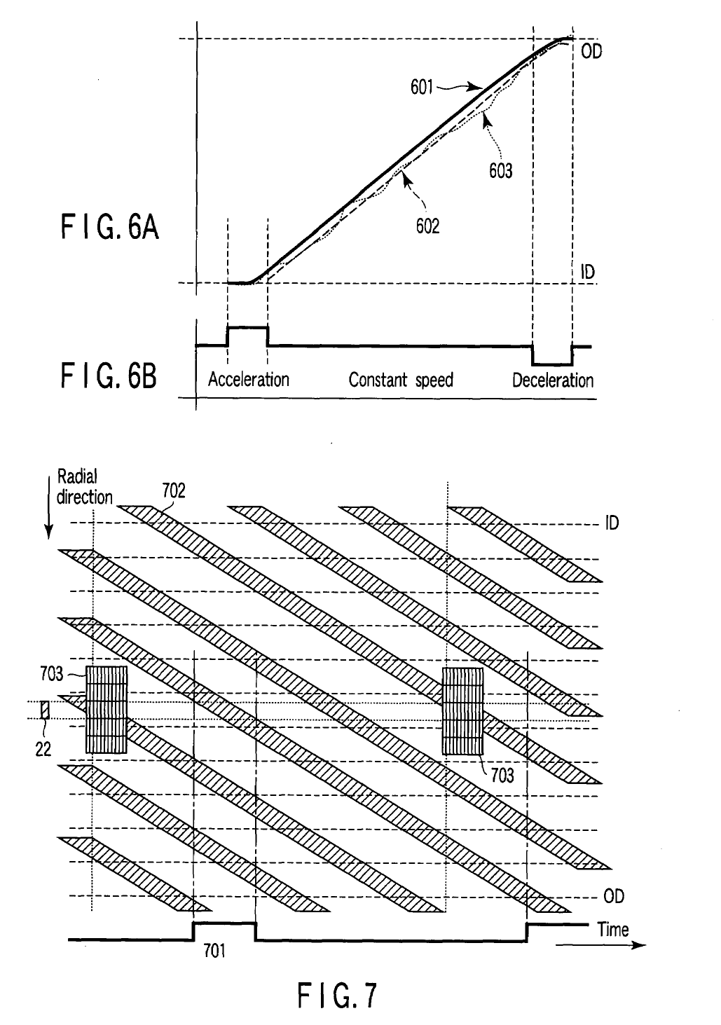

FIGS. 6A and 6B are diagrams explaining the seek operation of moving the head 22 in the self-servo writing process in accordance with the multi-spiral servo pattern. More precisely, FIG. 6A shows a full-stroke seek orbit, and FIG. 6B shows the acceleration at which head 22 moves along the seek orbit.

The self-servo writing process of this embodiment is a process of writing servo data using a spiral servo pattern as base pattern 50. Therefore, the concentric servo patterns can be written in a single full-track seek operation. This can greatly shorten the time required for writing the servo data.

As seen from FIG. 6A showing the full-stroke seek orbit the head 22 traces during the self-servo writing process in accordance with the multi-spiral servo pattern, the maximum seek speed indicated by broken line 602 differs from the nominal seek speed at which the head 22 moves along the nominal orbit indicated by solid line 601. Nonetheless, the head 22 moves at a constant speed, along the orbit indicated by broken line 602. The seek orbit indicated by dotted line 603 shows how the seeking speed changes due to an irregular disturbance.

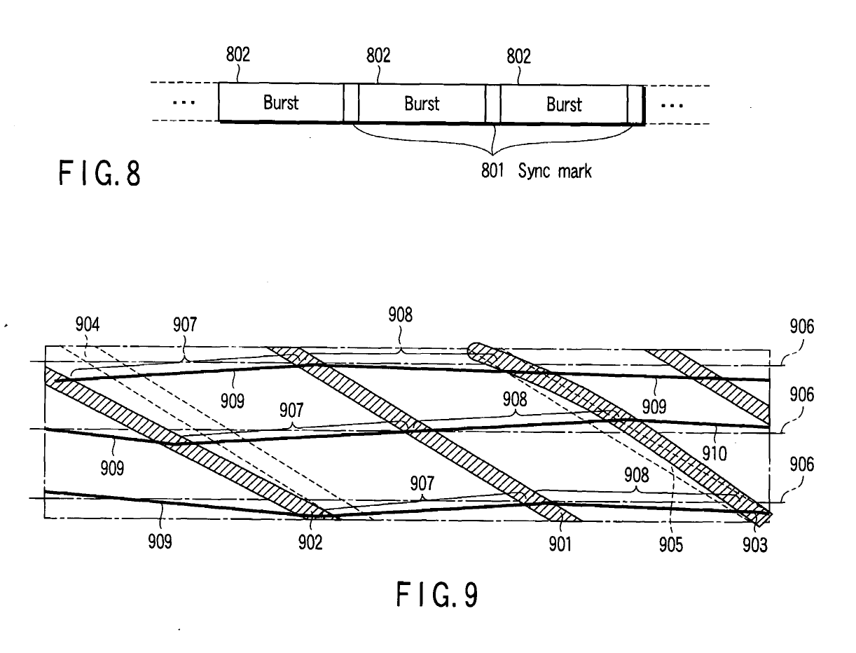

FIG. 7 is a diagram showing an example of a multi-spiral servo pattern that is used as base pattern 50. In FIG. 7, time is plotted on the abscissa and the position the head 22 takes in the radial direction is plotted on the ordinate. As shown in FIG. 7, the multi-spiral servo pattern 702 is a single spiral that consists of turns that extend parallel to one another and spaced at regular intervals. As shown in FIG. 8, the spiral pattern 702 is composed of pattern units, each composed of a sync mark 801 and a servo-burst pattern 802. The pattern units recur, without break.

In the servo writing process, the CPU 29 detects the position the head 22 takes in the radial direction of the disk medium 10, from the position of a servo gate 701, as is seen from FIG. 7. The CPU 29 acquires relative position data 703 for 10 to 20 cylinders (tracks) from the position of the servo gate 701, in accordance with the inclination of the turns of the spiral pattern 702.

The CPU 29 causes the head 22 to gradually move toward the inner or outer circumference of the disk medium 10, until the head 22 reaches a desired position over the disk medium 10. In moving the head 22 so in this seek operation, the CPU 29 uses, for example, the inner-circumference stopper provided in the disk drive 20, as reference position.

FIG. 9 is a magnified view of a part of FIG. 7. A spiral pattern 901 shown in FIG. 9 pertains to the seek orbit that is indicated by solid line 601 in FIG. 6. Another spiral pattern 902 shown in FIG. 9 pertains to the seek orbit that is indicated by broken line 602 in FIG. 6, along which the head 22 moves at a constant speed. This seek orbit indicated by broken line 602 deviates from a nominal orbit indicated by broken line 904.

Still another spiral pattern 903 is shown in FIG. 9. This pattern pertains to the seek orbit indicated by dotted line 603 in FIG. 6A, along which the head 22 moves at an inconsistent speed. The spiral pattern 903 deviates from a nominal orbit indicated by broken line 905.

In FIG. 9, solid lines 909 indicate three concentric servo tracks actually defined by the spiral patterns 901 to 903, respectively. Any track in which user data has been written by using a servo track will be called data track.

The concentric servo tracks 909 deviate from an ideal concentric track 906. Thus, during a period 908, calculation must be repeated to provide a correction value (STW-RRO correction value) for each servo sector if any two adjacent tracks differ in deviation from the ideal concentric track 906.

In disk drives developed in recent years, the tracks formed on each disk medium 10 are spaced but a very short distance, because data is recorded on the medium at a high density. Therefore, a change in the seek speed rarely influences the spaces between several adjacent tracks during the period 908 shown in FIG. 9. That is, the adjacent tracks can be assumed not to change in shape so much as during the period 907 shown in FIG. 9, in the process of writing servo tracks on the basis of the multi-spiral servo track.

In view of the above, the CPU 29 calculates a correction value for only those of the servo tracks provided on the disk medium 10, which are selected and spaced by designated regular intervals in the radial direction of the medium 10. Hence, the time required for calculating the correction value can be far shorter than in the case where the CUP 29 calculates a correction value for all servo tracks provided on the disk medium 10.

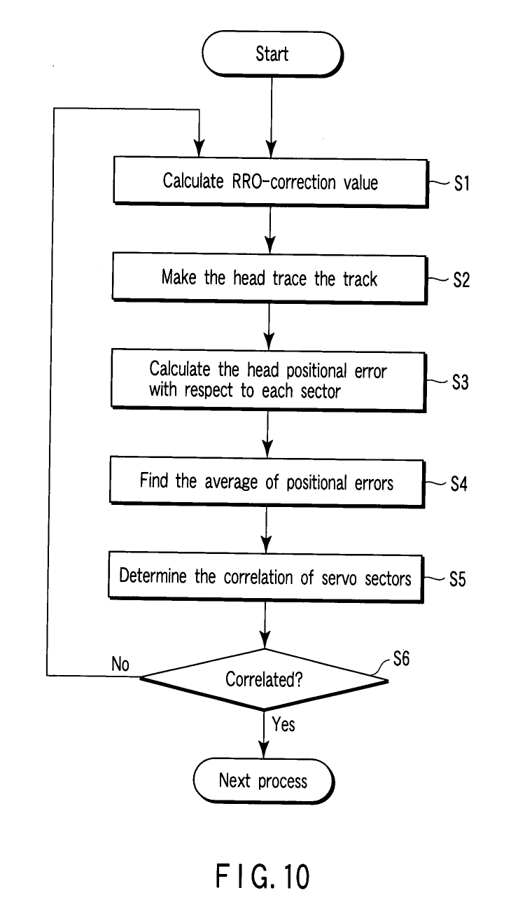

The correction value may be calculated not by the method described above, in which the intervals is mechanically designated, at which to space the servo tracks for which the correction value should be calculated. Another method of calculating the correction value will be explained with reference to the flowchart of FIG. 10.

First, the CPU 29 repeats calculation, providing corrections values (STW-RRO correction values) for all servo sectors of the innermost track of the disk medium 10 (Block S1). Next, using the correction values, the CPU 29 makes the head 22 move, tracing the immediately outer track (by repeating the head-positioning control several times) (Block S2). The correction values used at this point are those recorded in the servo sectors of the track inner in the radial direction of the disk medium.

Then, the CPU 29 measures the positional error the head 22 has with respect to each servo sector of the track it is tracing (Block S3). Further, the CPU 29 finds the average positional error the head 22 has every time the disk medium 10 rotates for 360° (Block S4).

The CPU 29 determines that any existing correction value cannot be used if the average of the positional errors measured for the servo sectors of the track does not change to zero in spite of using the correction values identical to those for the servo sectors of the inner track. In other words, the CPU 29 determines that any servo sectors adjacent in the radial direction are not correlated in terms of STW-RRO (Block S5).

If any servo sectors adjacent in the radial direction are not correlated (if NO in Block S6), the CPU 19 repeats calculation again, providing corrections values (Block S1). If any servo sectors adjacent in the radial direction are correlated (if YES in Block S6), it causes the head 22 to record the correction values hitherto used, in the servo sectors. Then, the CPU 29 makes the head 22 trace the next outer track.

Thus, if the adjacent tracks on the medium 10 are correlated in terms of STW-RRO, correction values are calculated not for all tracks on the disk medium 10 in order to suppress the STW-RRO change during the self-run test. That is, the corrections values are calculated only for some of the tracks on the medium 10. In this case, the correction values stored in the servo sectors of the track adjacent in the radial direction are used to control the position the head 22 has with respect to the servo sectors in which no correction values are stored. This shortens the time for calculating correction values, ultimately enhancing the efficiency of manufacturing the disk drive.

In the present embodiment, the time for calculating correction values can be reduced during, for example, the self-run test, and the efficiency of manufacturing the disk drive can therefore be enhanced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a head which writes and reads data;
a disk medium which has substantially concentric servo tracks, each formed of a plurality of servo sectors in which servo data is recorded for use in a positioning control of the head;
a head-moving mechanism which is configured to move the head to a designated position over the disk medium during the positioning control of the head;
a calculating unit which uses the servo data read the head has read from the disk medium, thereby calculating correction values that suppress changes synchronous with the rotation of the disk medium during the positioning control of the head;
a calculation control unit which controls the calculating unit, and causes the calculating unit to calculate a correction value for one of the servo tracks which has been designated, and stores the correction values, thus calculated, into a storage unit; and
a controller which uses the servo data and the correction values read from the storage unit, thereby controlling the head-moving mechanism and positioning the head at the servo track that has been designated.

2. The disk drive according to claim 1, wherein the calculating unit calculates a correction value for each servo sector, and the calculation control unit causes the calculating unit to calculate correction values for servo sectors included in several tracks designated and to store the correction values into the storage unit.

3. The disk drive according to claim 1, wherein the calculation control unit is configured to make the calculating unit calculate correction values used for only adjacent tracks correlated in terms of the changes, which have been designated, and to calculate correction values for any tracks not correlated with adjacent tracks in terms of the changes.

4. The disk drive according to claim 1, wherein the calculating unit calculates the correction values for each servo sector, and the calculation control unit is configured to make the calculating unit calculate correction values for only those of adjacent tracks correlated in terms of the changes, which have been designated, and to calculate correction values for the servo sectors of any tracks not designated and not correlated in terms of the changes.

5. The disk drive according to claim 1, wherein the calculating unit calculates the correction values for each servo sector, and the calculation control unit is configured to make the calculating unit calculate correction values for the servo sectors included in those of the servo tracks which have been selected and spaced by designated regular intervals and which include an innermost track and an outermost track.

6. The disk drive according to claim 1, further comprising a correlation determining unit configured to determine any servo track that has a positional error more than within a tolerance range has no correlation with the changes, when the positioning control of the head is performed by using the correction values the calculation unit has calculated for the servo track designated, wherein the calculating unit is configured to calculate correction values for any tracks determined not to be correlated with the changes, in addition to the correcting values for the servo track designated.

7. The disk drive according to claim 1, wherein the controller is configured to read from the storage unit the correction values for the tracks at which to position the head, and to use correction values for tracks adjacent or close to said tracks when no correction values are available for said tracks.

8. The disk drive according to claim 6, wherein the controller is configured to read from the storage unit the correction values for the tracks at which to position the head, and to use correction values for tracks adjacent or close to said tracks when no correction values are available for said tracks.

9. The disk drive according to claim 1, wherein the storage unit is a storage area included in a servo sector provided on the disk medium.

10. The disk drive according to claim 6, wherein the storage unit is a storage area included in a servo sector provided on the disk medium.

11. The disk drive according to claim 1, wherein the servo data recorded on the disk medium has been written by the head or a servo-track writer on the basis of a multi-spiral servo pattern recorded on the disk medium.

12. A method of testing servo data, for use in a disk drive having a head which writes and reads data; a disk medium which has substantially concentric servo tracks, each formed of a plurality of servo sectors in which servo data is recorded for use in a positioning control of the head; and a head-moving mechanism which is configured to move the head to a designated position over the disk medium during the positioning control of the head, the method comprising:
using the servo data the head has read from the disk medium, thereby calculating positional error changes synchronous with the rotation of the disk medium during the positioning control of the head;
calculating correction values for those of the servo tracks which have been designated, the correction values being values for suppressing changes synchronous with the rotation of the disk medium during the positioning control of the head; and
storing the correction values thus calculated, into a storage unit.

13. The method according to claim 12, further comprising:
determining that any servo track that has a positional error more than a tolerance range has no correlation with the changes, when the positioning control of the head is performed by using the correction values calculated for the servo track designated; and
calculating correcting values for any servo track designated and for any tracks determined not to be correlated with the changes.
